(19) United States
(12) Patent Application Publication
(10) Pub. No.: US 2018/0357742 A1
(43) Pub. Date: Dec. 13, 2018

(54) A METHOD FOR PROCESSING A SEQUENCE OF DIGITAL IMAGES, A METHOD OF WATERMARKING, DEVICES AND ASSOCIATED COMPUTER PROGRAMS

(71) Applicants: B<>COM, Cesson Sevinge (FR); Orange, Paris (FR)

(72) Inventors: Felix Henry, Saint Gregoire (FR); Patrice Houze, Rennes (FR); Emilie Sirvent-Hien, Rennes (FR); Gaetan Le Guelvouit, Thorigne-Fouillard (FR)

(21) Appl. No.: 15/778,657

(22) PCT Filed: Nov. 21, 2016
(86) PCT No.: PCT/FR2016/053036

§ 371 Date: May 24, 2018

(30) Foreign Application Priority Data
Nov. 24, 2015 (FR) 1561323

(51) Int. Cl. G06T 1/00; H04N 19/467; H04N 21/8358

(52) U.S. Cl. CPC G06T 1/0085; H04N 21/8358; H04N 19/467

(57) ABSTRACT

A method for processing a sequence of digital images. The method includes, for a current group: a) forming a main group including original images partitioned into spatial areas and including a watermarking zone; b) obtaining a main bitstream representing an area-based encoding of the images of the main group, in which for an area other than the watermarking area, the pixels of that zone are not predicted with reference to pixels in the watermarking area; c) for the watermarking area: forming a secondary group of images having the same temporal dimension as the main group and spatial dimensions equal to those of the watermarking area, inserting a first watermarking information value into the secondary group, and obtaining a first secondary bitstream representing images of the encoded secondary group including the first watermarking information value; and d) transmitting the main and first secondary bitstreams in the telecommunication network to a client.

### 1. CROSS-REFERENCE TO RELATED APPLICATIONS

This Application is a Section 371 National Stage Application of International Application No. PCT/FR2016/053036, filed Nov. 21, 2016, the content of which is incorporated herein by reference in its entirety, and published as WO 2017/089689 on Jun. 1, 2017, not in English.

### 2. FIELD OF THE INVENTION

The field of the invention is that of the transmission of encoded video content over a communication network, in particular the transmission of video content intended to be digitally watermarked before delivery to a client.

The invention may especially, but not exclusively, apply to tracking copy of a digital content.

### 3. DESCRIPTION OF PRIOR ART

Also known are watermarking techniques which consist in inserting a client code in a bitstream comprising encoded data representative of a video content intended for a client, in order to “watermark” the copy of the video content before delivery to the client.

Among these techniques, the one consisting in transmitting the client code by inserting the bits that form the code word in consecutive groups of images of the encoded stream, is considered in particular.

In relation with FIG. 1A, there is shown a current image group GC of a sequence of digital images Im, with m a non-zero integer between 1 and M. Typically, such a group GC comprises N images, with N a non-zero integer smaller than M, duration of 1 to 2 seconds, which corresponds to N=25 or 50 images for a image rate of 25 images per second.

It is assumed that the watermarking information to be inserted into the segment is binary. On the one hand, a first group G1 is formed in A11 in which the value T1=0 is inserted into the intensities of the image elements or pixels of the current group GC and the first group is encoded at A21. We obtain a first bitstream TBT1.

On the other hand, a second group G2 is formed at A21 in which the value T2=1 is inserted into the intensities of the pixels of the current group GC and the second group is encoded at A22. We obtain a second bitstream TBT2.

The bitstreams TBT1 and TBT2 obtained are stored in a memory M. For a given quality level, it is therefore necessary to provide an encoded version of the G1 group containing a first symbol and a second version of the same group G2 containing a different symbol. In the binary case, it is customary to use a version carrying the bit 0 and a version carrying the bit 1.

It is understood that at a point in the network on the path followed by the data stream to the client, a group assembly specific to the client is made, to transmit the watermarking code that identifies it.

FIG. 1B illustrates an assembly example for a client whose identifier IDCL is the sequence of symbols T1T2T1T2. This identifier can be transmitted in the encoded data of 4 consecutive image groups GC1, GC2, GC3 and GC4, the bitstream TBT1 (GC1) associated with GC1 carrying the value T1, the bitstream TBT2 (GC2) associated with GC2 carrying the value T2, the bitstream TBT1 (GC3) associated with GC3 carrying the value T1 and the bitstream TBT2 (GC4) associated with GC4 carrying the value T2.

Such an assembly can be implemented at the server which stores the bitstreams corresponding to different watermarked versions of the encoded groups or further downstream, for example at an intermediate equipment or in the client terminal.

The article by Kopilovic et al, titled “Video-DNA: Large-scale server-side watermarking» published in the proceedings of the conference entitled, 15th European Signal Processing Conference in 2007 describes several approaches to watermark encoded data representative of audiovisual content. In particular, it describes an “all-server” approach, according to which the server is responsible for the assembly for each client and sends as many bitstreams as clients to the network, an “all-client” approach where the client equipment carries out all the watermarking operations, the same bitstream being sent to all clients. This second approach requires significant computing capabilities on the client side. An intermediate approach is to transmit the two current watermarked group versions with different values to the client who is responsible for the final assembly. The transmission network is then loaded but the assembly does not require significant computing capacity.

With a view to their transmission to the client(s), the bitstreams relating to a group of images are encapsulated in a transport container for example specified by the ISO/IEC 14496-12 multimedia flow transport standard, known as ISOMBFF (for “ISO Base Media File Format”). An extension of this standard provides for the possibility of transporting a main bitstream comprising encoded data representative of a group of images in which a first watermarking information value has been spread out and at least one variant of this bitstream representative of the same group of images, in which a second watermarking value was spread.

We know a video content transmission technique, called HAS (“http adaptive streaming”) comprising storing server-side time segments; several encoded versions of the same video content, corresponding to different quality levels. A client who wishes to receive content, first requires a description file, MPD or manifest, of the server-side available streams and commands the server to deliver the quality-level segment appropriate to the network transmission conditions available. The version can be changed over time depending on the evolution of these conditions. This technique is described in particular in the article entitled «Dynamic Adaptive Streaming over http (DASH)—Standards and Design Principles», by Thomas Stockhammer, published in the Proceedings of the « ACM Conference on Multimedia Systems, in February 2011, pages 133-144.

In such a context of adaptive transmission of encoded audiovisual content, the main bitstream comprising a first watermarking information value and its variant or variants containing at least one other watermarking information value are segmented temporally. For each time segment, a client orders, from the qualities available, the one which is the most adapted to its resources. The server responds by transmitting the main bitstream corresponding to the selected segment and at least one variant. A client-specific watermark can be made at a point in the path followed by the bitstreams, more or less close to the end client.

### 4. DISADVANTAGES OF THE PRIOR ART

A disadvantage common to all these approaches is an additional cost of resources, in terms of calculation, storage and bandwidth, since in any case it is necessary to have two complete encoded versions of each segment at each level of available quality. The size of the data to be processed, stored and transmitted is therefore potentially doubled.

### 5. SUMMARY OF THE INVENTION

An exemplary embodiment of the invention relates to a method for processing a sequence of digital images for transmission to at least one client via a telecommunication network, said sequence being cut into a plurality of groups of images.

According to the invention, the method is particular in that the images of a group being partitioned into spatial zones, it comprises the following steps, implemented for a group of images, so-called current group:
a) forming a main group comprising the original images of the current group, said images being partitioned into at least two predetermined spatial areas, located at the same spatial coordinates, or collocated, in the images of the current group and comprising at least one so-called watermarking zone;
b) obtaining a main bitstream representative of an area-based encoding of the images of the main group formed, in which for an area other than said at least one watermarking area, the pixels of that zone are not predicted with reference to pixels in the watermarking area of a image of the group;
c) for one said watermarking area:
   forming a secondary group of images of the same temporal dimension as the main group and of spatial dimensions equal to those of the watermarking area;
   inserting a first watermarking information value into the secondary group formed;
   obtaining a first secondary bitstream representative of the images of the encoded secondary group including the first watermarking information value;
d) transmitting the main bitstream, and said at least one first secondary bitstream in the telecommunication network to at least one client.

Unlike the solution of the prior art, which duplicates the bitstreams comprising the encoded data of a segment of the image sequence in as many versions as possible values of the watermarking information, the invention proposes to limit the duplication of the encoded data for the same segment, by watermarking only a subset of the pixels of the images of this segment.

According to the invention, at least one secondary group of images is constructed whose spatial dimensions are those of the watermarking area and the temporal dimensions of those of the current group. This results in a sequence of “thumbnails” of smaller size than the images of the original group. Within the intensities of the pixels of these “thumbnails”, a value of the watermarking information is inserted. The secondary group is then encoded as a small independent sequence, in a so-called secondary bitstream.

The main group, whose images are partitioned in spatial areas, collocated in the group images, is encoded by spatial area, so that from the bitstream obtained, it is possible to access the encoded data representative of the watermarking area and replace them with others of the same spatial and temporal dimensions, such as for example that of a secondary group.

With the invention, the main bitstream and the secondary bitstream(s) obtained for the current group are independent and recomposable into a bitstream including the desired watermarking information value, for example for a particular client. A secondary bitstream, because it encodes spatial areas smaller than those of a image in the main group, requires less computing resources to be processed, occupies less memory space, and requires fewer network resources to be transmitted as the main bitstream.

The invention thus exploits the encoding functionality, by adapting it, by spatial area to limit the extra cost generated by the watermarking of a video content. The invention thus makes it possible to save storage and transmission resources, which is all the more important as the watermarked space area is smaller.

According to an advantageous characteristic of the invention, the method further comprises a step of inserting a second watermarking information, distinct from the first, into the watermarking area of the main group formed.

Let us assume that the watermarking information is binary and the watermarking code of a client is formed by concatenating a number of binary watermarking information or symbols. According to the invention, the main bitstream carries a first value, for example 0 and the secondary bitstream a second value distinct from the first, for example 1. Because of the area-based encoding as specified by the invention, it is possible to extract the watermarking area comprising the 0 from the main segment and replace it with the watermarking area of the secondary segment comprising zero. The invention thus provides, from the main bitstream and a secondary bitstream, the elements to construct for the current segment, the bitstream comprising the symbol corresponding to the intended client.

One advantage of this solution is to be very resource efficient. According to another aspect of the invention, the method further comprises the following steps:
for a watermarking area:
   forming a secondary group of images of the same temporal dimension as the main group and of spatial dimensions equal to those of the watermarking area;
   inserting, in the second secondary group formed, at least one second watermarking information value;
   obtaining at least one second secondary bitstream comprising encoded data representative of the secondary group including the second watermarking information value;
   transmitting said at least one second secondary bitstream to at least one client.

This alternative is to transmit the first and at least the second watermarking value in secondary bitstreams corresponding to a watermarking area. It has the advantage of being generic in the sense that it does not require watermarking at the source of the main stream. It therefore allows a pre-routing of generic bitstreams in the network, for example in multicast mode and a specific processing for each client as far downstream as possible.

According to yet another aspect of the invention, the step of forming the main group comprises replacing the original intensities of said at least one watermarking area with predetermined intensity values.

Since the original values of the image group have been replaced in the watermarking area with predetermined values, a client cannot obtain the complete video content from the single main bitstream, which is amputated part of the content. An advantage of this embodiment is that it is more secure.

According to another aspect of the invention, the predetermined values are invariable values.

An additional advantage is that the spatial area corresponding to the watermarking area in the main segment is inexpensive to encode with an encoder implementing a prediction of pixels of a current image from pixels of a image already processed.

According to another aspect of the invention, the step of forming a secondary group for a watermarking area comprises an extraction of the intensity values of the pixels of the watermarking area in the original images of the current group.

Thus, the secondary bitstreams encode the original video content into the watermarking area, in which a watermarking information value has been inserted. One advantage is that the recomposition of the main and secondary bitstreams by replacing the encoded data concerning the watermarking area of the main bitstream with that of a secondary bitstream comprising watermarking information, leads to reconstructing the entire video content by recomposition of the bitstreams received without loss of relevant information.

According to still another aspect of the invention, the method comprises a step of choosing said at least one watermarking area among the partitioned areas.

The invention thus allows the possibility of changing watermarking area from one segment to another. One advantage is to change the location of the watermarking area when processing a new segment, for example to hide relevant content. One can consider taking into account semantic information to choose the watermarking area, for example to follow an object or character that moves in the image.

According to yet another aspect of the invention, the method further comprises a step of determining an enlarged watermarking area in the images of the main group, comprising the watermarking area and a predetermined width border around said area. The area encoding comprises a step of applying a filter of size less than or equal to the predetermined width at the borders of the areas of the images of the main group and for an area of a image other than said at least one watermarking area, the prediction of the pixels of the area does not refer to the pixels of said at least one enlarged watermarking area of another image of the group.

In this way it is guaranteed that the filtering does not change the rest of the image with information contained in the watermarking area, which is intended to be replaced with recomposition.

According to still another aspect of the invention, the partitioning implemented in the step of forming the main group comprises at least a first and a second watermarking areas and the step of inserting at least a first watermarking information into the secondary group comprises inserting a first watermarking information into the first area and a third watermarking information into the second area. This third watermarking information may take the first or second value in the binary case.

An advantage of this embodiment of the invention is that at least two symbols can be transmitted in the same segment and a watermarking code word comprising several symbols can be transmitted over a time period that is two times shorter. Thus, the transmission of the content is made more robust to capture a short extract of the sequence.

The method that has just been described in its various embodiments is advantageously implemented by a device for processing a sequence of digital images for transmission to at least one client via a telecommunication network, said sequence being cut into a plurality of groups of images. Such a device being particular in that the images of a group being partitioned into spatial zones, it comprises the following units, which can be implemented for a group of images, so-called current group:
a) forming a main group comprising the original images of the current group, said images being partitioned into at least two predetermined spatial areas, located at the same spatial coordinates, or collocated, in the images of the current group and comprising at least one so-called watermarking zone;
b) obtaining a main bitstream representative of an area-based encoding of the images of the main group formed, in which for an area other than said at least one watermarking area, the pixels of that zone are not predicted with reference to pixels in the watermarking area of a image of the group;
c) for one said watermarking area:
   forming a secondary group of images of the same temporal dimension as the main group and of spatial dimensions equal to those of the watermarking area;
   inserting a first watermarking information value into the secondary group formed;
   obtaining a first secondary bitstream representative of the images of the encoded secondary group including the first watermarking information value;
d) transmitting the main bitstream, and said at least one first secondary bitstream in the telecommunication network to at least one client.

Correlatively, the invention also relates to a method for watermarking a sequence of digital images transmitted in a telecommunication network to at least one client, said sequence being divided into groups of images, characterised in that said method comprises the following steps, implemented for one such group, so-called current group:
obtaining beforehand one value representative of at least one watermarking information, so-called client watermarking information, to be inserted into the current group for said at least one client;
receiving a main bitstream comprising the encoded data representative of a main group, formed from the original images of the current group partitioned in at least two predetermined spatial areas, located at the same spatial coordinates, or collocated, in the images of the group and comprising at least one so-called watermarking area, the encoded data having been obtained by encoding each spatial area of the main group, according to which the prediction of the pixels of a image area of the group other than said at least one watermarking area is not made with reference to the pixels of said at least one watermarking area of said image or other image of the group;
obtaining information relating to a watermarking information value inserted into the current group of the main bitstream received;
When the value obtained is not equal to the watermarking information of the client, the method furthermore comprises:
   for one said watermarking area:
      receiving at least a first secondary bitstream comprising encoded data representative of a secondary group of images, wherein a watermarking information value equal to the watermarking information of the client has previously been inserted, said secondary group being of the same temporal dimension as the main group and of spatial dimensions equal to those of the watermarking area;
      forming a bitstream intended for said at least one client, by replacing the encoded data associated with said at least one watermarking area in the main group with the encoded data of the secondary bitstream.

Before delivering the video content to the client, the bitstreams are recomposed to insert the one or several pieces of watermarking information adapted to the recipient client.

The method according to the invention can be implemented at different points of the path followed by the main and secondary bitstreams. For example, at the client level (set top box), the forming will be client-specific and a watermark to uniquely identify it will be inserted into one or more groups in the sequence. The recomposed bitstream will then be presented to the decoder.

Further upstream in the network, it is possible to envisage a partial forming, implemented by an intermediate network equipment (middle box), for example a server or a DSLAM type equipment serving a certain number of clients, and relating to the information watermarking common to many of them. In this case, the recomposed bitstream is transmitted to the client(s) instead of the primary and secondary bitstreams.

It can also be implemented directly by the server for a point-to-point delivery, dedicated to a particular client. According to this option, it is a bitstream specifically recomposed for the client that is sent by the server.

The method just described is advantageously implemented by a watermarking device of a sequence of digital images transmitted in a telecommunication network to at least one client. The sequence is divided into groups of images. The device according to the invention comprises the following units, which can be implemented for one group, so-called current group:
obtaining beforehand one value representative of at least one watermarking information, so-called client watermarking information, to be inserted into the current group for said at least one client;
receiving a main bitstream comprising the encoded data representative of a main group, formed from the original images of the current group partitioned in at least two predetermined spatial areas, located at the same spatial coordinates, or collocated, in the images of the group, and comprising at least one so-called watermarking area, the encoded data having been obtained by encoding each spatial area of the main group, according to which the prediction of the pixels of a image area of the group other than said at least one watermarking area is not made with reference to the pixels of said at least one watermarking area of said image or other image of the group;
obtaining information relating to a watermarking information value inserted into the current group of the main bitstream received;
When the value obtained is not equal to the watermarking information of the client, the device furthermore comprises:
   for one said watermarking area:
      receiving at least a first secondary bitstream comprising encoded data representative of a secondary group of images, wherein a watermarking information value equal to the watermarking information of the client has previously been inserted, said secondary group being of the same temporal dimension as the main group and of spatial dimensions equal to those of the watermarking area;
      forming a bitstream intended for said at least one client, by replacing the encoded data associated with said at least one watermarking area in the main group, with the encoded data of the secondary bitstream.

The invention also relates to a communication equipment capable of receiving one or more bitstreams comprising encoded data representative of a sequence of images from a server equipment and to transmit them to one or more client equipment recipients and the device of watermarking that has just been described.

The invention also relates to a client equipment capable of receiving one or more bitstreams comprising encoded data representative of a sequence of images from a server equipment, said equipment comprising a decoder capable of decoding the received bitstreams and the device of watermarking which has just been described.

Correlatively, the invention relates to a signal carrying encoded data representative of a sequence of digital images for transmission to at least one client via a telecommunications network, said sequence being divided into groups of images, characterised in that, for one group, so-called current group, said encoded data comprise:
a main bitstream comprising the encoded data representative of a main group, formed by partitioning the original images of the current group into at least two predetermined spatial areas, located at the same spatial coordinates, or collocated, in the images of the main group and comprising at least one so-called watermarking area, said areas having been obtained by area-based encoding of the images of the main group, according to which for an area other than said at least one watermarking area, the pixels of the area are not predicted with reference to pixels in the watermarking area of a image of the main group;
for said at least one watermarking area;
   at least one first secondary bitstream comprising encoded data representative of images of a secondary group, of the same temporal dimension as the main group and of spatial dimensions equal to those of the watermarking area, in which a first representative value of a watermarking information has been inserted;
said bitstreams being intended to be received by an equipment adapted to determine at least one watermarking information value to be associated with at least one client, and, when the value of the watermarking information of the client is equal to the first watermarking information to be recomposed, from the bit trains received, a bitstream intended for said at least one client, by replacing the encoded data of the main bitstream associated with said at least one watermarking area in the main group with the encoded data of the secondary bitstream.

According to one aspect of the invention, for said at least one watermarking area, a second watermarking information value having been inserted in the watermarking area of the images of the main group, the main bitstream comprises encoded data representative of the images of the main group and the second watermarking information value.

In this way, in the case of binary watermarking information, two bitstreams are sufficient to construct all possible values of client identifiers.

The invention further relates to a computer program comprising instructions for implementing the steps of a method for processing a sequence of digital images as described above, when this program is executed by a processor.

The invention also relates to a computer program comprising instructions for implementing the steps of a method of watermarking as described above, when this program is executed by a processor.

These programs can use any programming language. They can be downloaded from a communication network and/or recorded on a computer-readable medium.

The invention finally relates to recording media, readable by a processor, integrated or not integrated with the device for processing a sequence of digital images and with the device for watermarking a sequence of digital images according to the invention, which is optionally removable, thereby storing respectively a computer program implementing a method for processing and a computer program implementing a method of watermarking, as described above.

### 6. LIST OF FIGURES

Other features and advantages of the invention will become evident on reading the following description of one particular embodiment of the invention, given by way of illustrative and non-limiting example only, and with the appended drawings among which:

FIGS. 1A and 1B (already described) schematically show a method for transmitting a sequence of digital images comprising watermarking information according to the prior art;

FIG. 2 shows schematically a method for processing a sequence of digital images according to a first embodiment of the invention;

FIGS. 3A and 3B illustrate two examples of space area partitioning of images of a time segment of a sequence of digital images implemented by the method for processing a sequence of digital images according to the invention;

FIG. 3C illustrates an exemplary region encompassing a watermarking area, implemented during the encoding of the main group of images according to the invention;

FIG. 4 schematically shows the steps of a method for watermarking a sequence of digital images according to the first embodiment of the invention;

FIG. 5A schematically illustrates an exemplary processing of a sequence of digital images by a server equipment according to the first embodiment of the invention;

FIG. 5B schematically illustrates an example of implementation of the method of watermarking according to the first embodiment of the invention;

FIG. 6A schematically illustrates an example of segmentation of the bitstreams resulting from the method for processing a sequence of digital images according to the invention by an intermediate device;

FIG. 6B schematically illustrates an example of combined implementation of the method of watermarking according to the first embodiment of the invention and a segmentation of bitstreams by an intermediate equipment;

FIG. 7 shows schematically a method for processing a sequence of digital images according to a second embodiment of the invention;

FIGS. 8A and 8B illustrate two examples for choosing a watermarking area in a current segment according to the invention;

FIG. 9 schematically shows the steps of a method for watermarking a sequence of digital images according to the second embodiment of the invention;

FIG. 10A schematically illustrates an exemplary embodiment of the method for processing a sequence of digital images by a server equipment according to the second embodiment of the invention;

FIG. 10B schematically illustrates an exemplary embodiment of the method for watermarking a sequence of digital images by an intermediate or client equipment according to the second embodiment of the invention; and

FIGS. 11A and 11B schematically show examples of the hardware structure of a device for processing and of a device for watermarking a sequence of digital images according to the invention.

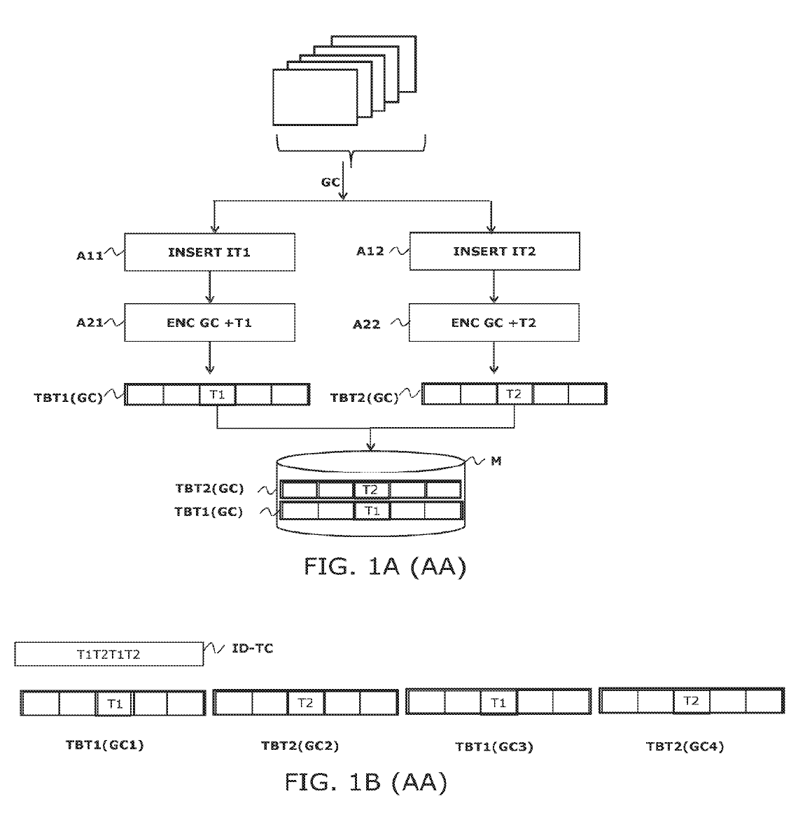

### 7. DESCRIPTION OF A PARTICULAR EMBODIMENT OF THE INVENTION

The general principle of the invention is based first of all on the partitioning in spatial areas of the images of a current group of images of a sequence of digital images comprising at least one watermarking area. It also comprises the insertion of watermarking information into the watermarking area and the independent encoding of one or more watermarked versions of that watermarking area, so that its encoded data can be easily inserted into a main bitstream of the current group, before delivery to a client and without transcoding operation.

Hereinafter, a sequence of images divided into consecutive groups of images, for example of 2 second duration, comprising 50 images, is considered. A group of images may or may not correspond to a GoP (for “Group of Pictures”) in the terminology of video compression standards such as HEVC for “High Efficiency Video Coding” or AVC (for “Advanced Video Coding”) for example.

It should be noted that the invention applies to any type of image sequence and in particular to a sequence of images obtained from an immersive video, that is to say from a video recording of a video real-world scene where images are captured in multiple directions at the same time, around a central point, corresponding to the user's position. During the viewing, the acquired images are projected for example on a cube from the centre of which the user can control the angle of view and the speed of movement. In this case, a image of the sequence within the meaning of the invention comprises the six unfolded faces of the cube.

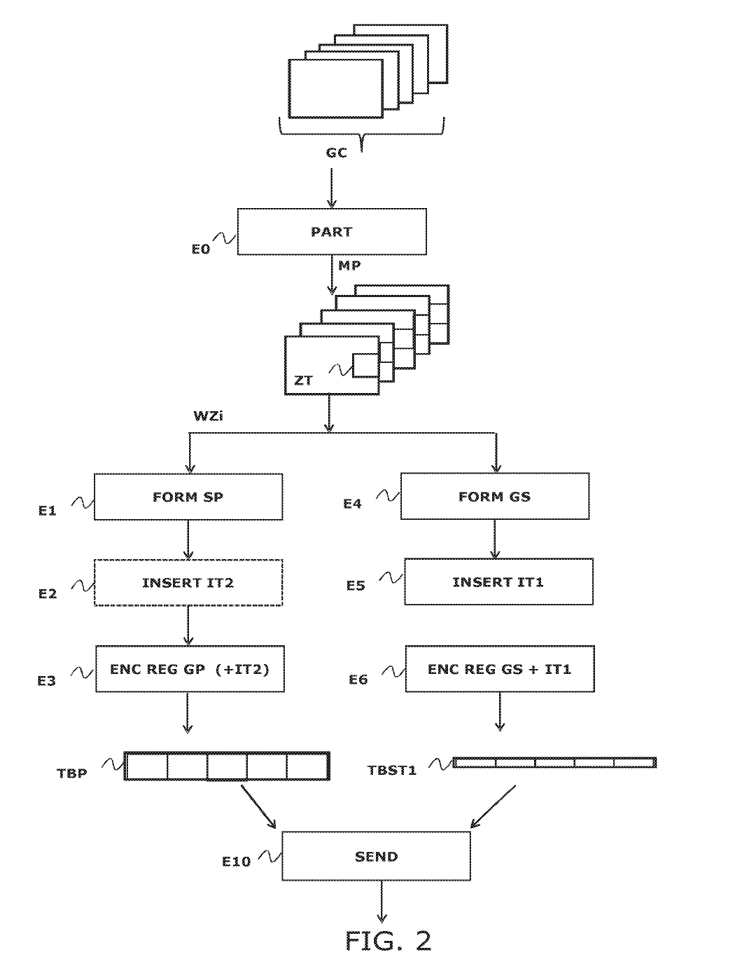

In connection with FIG. 2, the steps of a method for processing a image sequence according to a first embodiment of the invention are described.

In particular, a current image group GC of the image sequence is considered. During a step E0, each of its images is partitioned into at least two spatial areas, according to a predetermined partitioning scheme. At least one of these areas constitutes a watermarking area ZT.

A priori, any type of spatial partitioning can be considered. However, in practice, it must be authorised by the coding scheme of the image sequence.

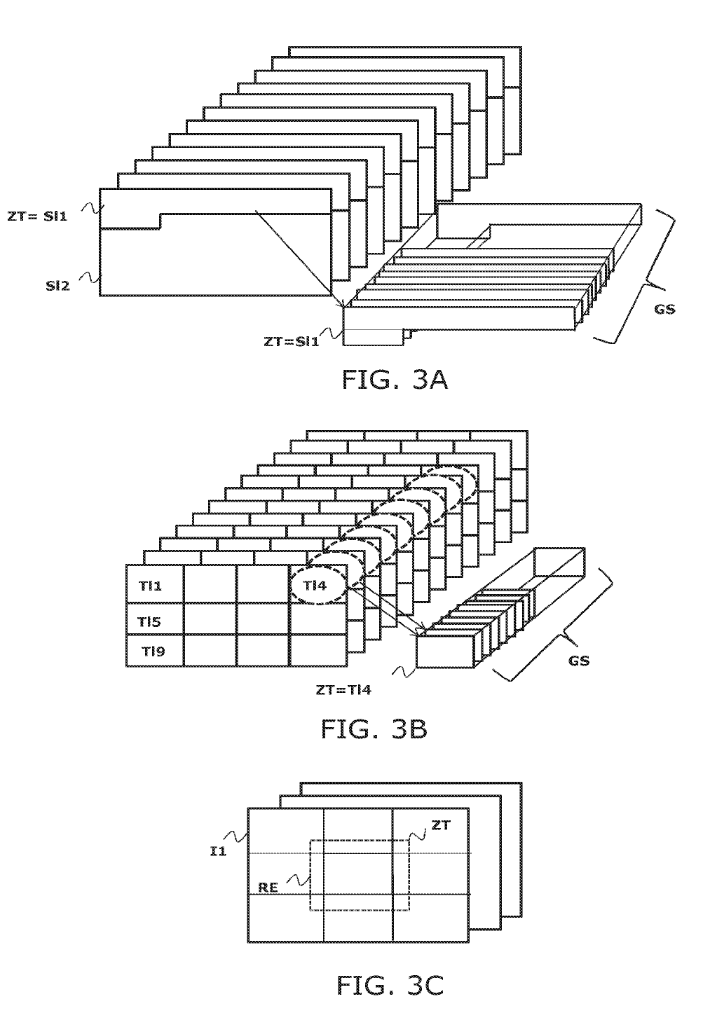

In connection with FIG. 3A, there is shown an example of partitioning into two slices S11, S12, as specified in the AVC standard, by lain E. Richardson, in section 5.6 of the book entitled ‘The H.264 Advanced Video Compression Standard’, 2nd Edition, ISBN: 978-0-470-51692-8), published in April 2010 by Wiley. These two slices can be encoded independently of each other according to a particular mode of the AVC standard.

In this example, the watermarking area ZT1 corresponds to the slice S11, for which it is possible to generate a bitstream specific to this area, comprising encoded data independent of those of the current group GC.

In connection with FIG. 3B, there is shown a second example of partitioning images of the current group of images, into tiles. This partitioning scheme is described in the HEVC specification by Sze, Vivienne, Budagavi, Madhukar, Sullivan, Gary J. (Eds.), entitled «High Efficiency Video Coding (HEVC) Algorithms and Architectures», ISBN 978-3-319-06895-4, DATE, as well as an independent encoding of each tile.

In this example, the watermarking area ZT is the tile T14. This tile can be the subject of an independent encoding and the construction of a specific bitstream.

During a step E1, a main group GP is formed from the partitioned current group. This main group has the same temporal and spatial dimensions as the current group. The information, in particular the intensity carried by the elements of these images, pixels or voxels, is unchanged with respect to the current group in the spatial areas other than the watermarking area ZT.

Regarding the Watermarking area ZT, several options are envisaged:
either the same intensity information is preserved as in the current group;
or the original values of this intensity information are replaced with determined values, for example invariant values on all the images of the main group.

According to the first embodiment of the invention illustrated in FIG. 2, the same information is preserved in the watermarking area of the main group as in the current group. At this point, the main group is identical to the current group.

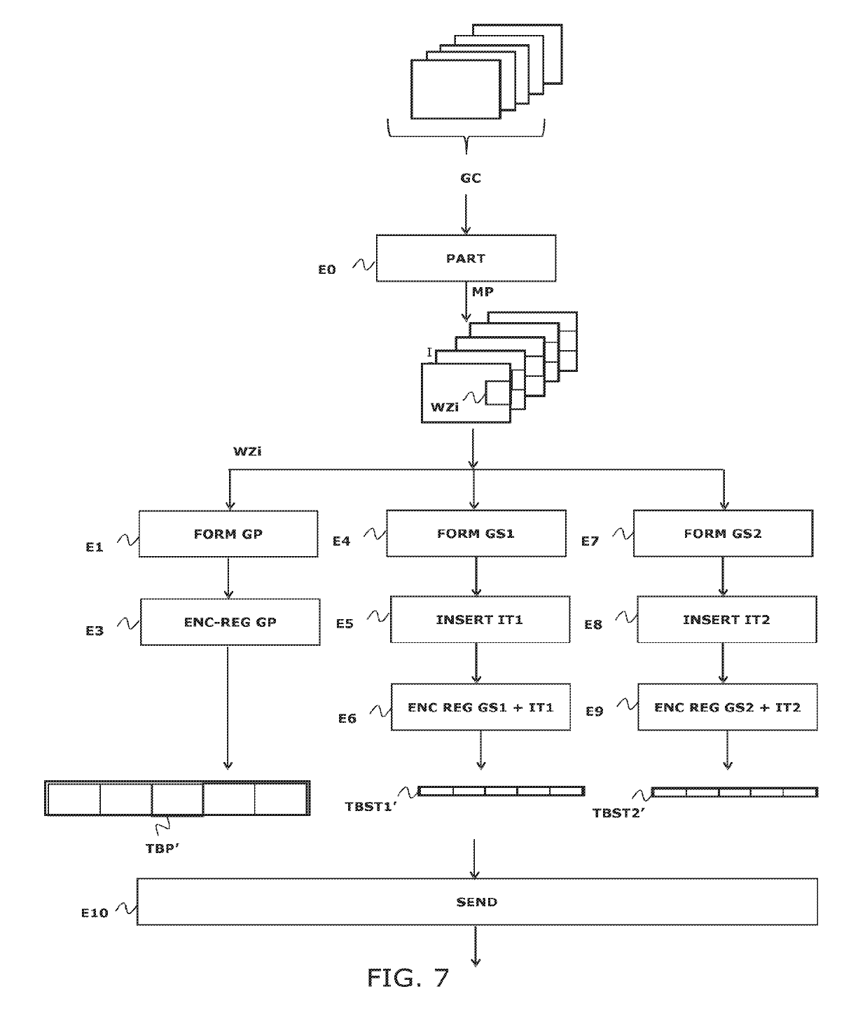

During a step E2, watermarking information IT2 is inserted into the watermarking area ZT of the main group SP. This watermarking information can be binary or n-ary. In FIG. 2, this step has been shown schematically by a dotted box, to indicate that it is not essential to the implementation of the invention. An alternative, according to which no watermarking information is inserted into the main bitstream will be presented in connection with FIG. 7.

The insertion of the watermarking information is done according to a method known to those skilled in the art, for example that described in the article by Cox et al, entitled “Secure Spread Spectrum Watermarking Multimedia”, published in IEEE Trans. on Image Processing, 6, 12, pp 1673-1687, in 1997. This method relies on the use of a spread spectrum function to transform a binary symbol into a sequence to be added to the elements of the image sequence in the space or frequency domain (these elements may be pixels, or coefficients of a frequency transform DCT type for Discrete Cosine transform, or DWT for Discrete Wavelets transform.

Let I be the vector representing the set of m elements that we wish to watermark, from the area ZT. In this embodiment, it is the set of coefficients resulting from the frequency transform of the images of a group of images.

A sequence denoted G is generated from a pseudo-random generator of length m. The elements of this sequence G must follow a Normal distribution cantered in 0. The watermark of the bit b in Ii is then given by the formula (1):

I[j]+a.G[j] if b=1, (1)

I[j]−a.Gᵢ[j] if b=0, for any j between 1 and m.

The factor a>0 is a weighting to adjust the trade-off between mark strength and its visibility.

The reading of the watermark symbol from the image J is given by the formula (2):

b=0 if Σⱼ₌₁^{m} J[j].G[j]<0, (2)

bᵢ=1 otherwise.

For example, let us consider a group of images of dimensions 1080p, which corresponds to 1920×1080 pixels, which is divided into 9 identical spatial areas. If the central area is chosen solely as a watermarking area, the watermarking information will be spread over the 640×360 pixels of the watermarking area of the images of the group of images considered.

During a step E3, the main image group is encoded according to an area-based encoding technique, known per se. This encoding by spatial area can be advantageously achieved for example by implementing a so-called tile encoding technique, described in the specifications of the HEVC standard by Sze, Vivienne, Budagavi, Madhukar, Sullivan, Gary J. (Eds.), entitled High Efficiency Video Coding (HEVC) Algorithms and Architectures, ISBN 978-3-319-06895-4, DATE.

A “slice” type spatial area encoding is also described in the AVC standard, by kin E. Richardson, in “The H.264 Advanced Video Compression Standard”, 2nd Edition, ISBN: 978-0-470-51692-8, DATA. A property of a slice/tile is that it can be decoded independently of other tiles in the current image, because the encoding of a tile does not introduce dependence with pixels of other tiles of the current image.

Also known is a technique of imposing constraints on a tile to make an independently decodable video stream and recomposable with other tiles to form a new video stream. This technique is described by Christian Feldmann, Christopher Bulla, Bastian Cellarius, in the document entitled “Efficient Stream-Reassembling for Video Conferencing Applications using Tiles in HEVC”, MMEDIA 2013, in the Proceedings of the conference «The Fifth International Conferences on Advances in Multimedia», Pages 130 to 135, in April 2013. The constraints to be applied are, on the one hand, to have a tile-cutting structure that is the same on the sequence of images concerned, and on the other hand, encode these tiles by ensuring that the blocks of pixels contained in a tile are predicted only by pixels contained in this same tile or pixels belonging to a tile located at the same spatial coordinates in another image of the series concerned.

According to the invention, it is imposed as a particular constraint the fact of not allowing any prediction of elements or blocks of elements contained in spatial areas of a image of the main image group other than the watermarking area in the same image or in a image previously processed. In this way, the encoded data contained in the watermarking area may be modified, for example replaced with others without impact on the encoded data of the other spatial areas of the main image group.

Advantageously, the prediction of elements or blocks of elements contained in distinct spatial areas of the watermarking area is prohibited, by pixels contained in a region more broadly encompassing the watermarking area. Indeed, it is known in the HEVC standard that when a image is subdivided into tiles, a reduction filtering of discontinuities is applied along the boundaries of the blocks, and therefore in particular along the boundaries of the tiles. Such filtering is described for example in the document by Norkin et al, entitled «HEVC Deblocking Filter», published in the review IEEE Transactions on Circuits and Systems for Video Technology, vol. 22, no. 12, December 2012. When HEVC compliant filtering is applied, the four rows of pixels on each side of the tile boundary take on new values that depend on the value of the pixels located on the other side of the border before filtering. In connection with FIG. 3C, there is shown an example of RE region encompassing the watermarking area ZT. It comprises the watermarking area and a predetermined width margin around this area. It is forbidden to predict pixels outside the watermarking area ZT by pixels in the region RE which comprises the pixels of the area ZT as well as the 4 rows of pixels immediately adjacent to ZT. Indeed, the pixels located in the region RE are likely to take a modified value when the content of the watermarking area ZT is modified to adapt to the watermarking information, which would introduce an error in the prediction. Prohibiting this prediction thus makes it possible to avoid propagating prediction errors that would be detrimental to the quality of the reconstructed video.

The intensity information of the watermarking area and the watermarking information IT2 that has been inserted therein are therefore encoded in the same bitstream TBP as the other areas of the main image group, but independently.

For example, the encoded data representative of the watermarking area in the consecutive images of the main image group can be placed after the encoded data representative of the other spatial areas of the other images of the main image group, for example at the end of the bitstreams comprising the encoded data of the main group.

In particular, specific signalling is implemented to allow identification of the encoded data corresponding to this watermarking area, without requiring decoding the data. This signalling can take the form of a start code, that is to say a sequence of bits known a priori, which serves to mark the beginning of the data corresponding to a tile. Alternatively, it may also take the form of length information, comprising the number of bits to count from the beginning of the segment data to arrive at the beginning of the data associated with the tile.

An example of signalling is for example already specified in the extension of the ISO BMFF standard, already mentioned, to indicate the positioning of the encoded data of the main bitstream to replace those of a variant.

During a step E4, a group of secondary images GS is formed from the intensity information contained in the watermarking area ZT of the current group GC. Said secondary group has the same temporal dimension as the main group and the same spatial dimensions as those of the watermarking area ZT. Examples of secondary groups formed from the common group are shown in FIGS. 3A and 3B, already described.

Advantageously, the intensity information of the elements of the watermarking area ZT of each of the images of the current group is extracted and copied into those of the secondary group GS. In this way, when the encoded data representative of the secondary group GS is inserted in place of that of the watermarking area of the main group, it will be possible to recompose a complete bitstream of the current group, without loss of useful information.

Of course, one can also choose predetermined intensity values, for example invariable from one image to another of the secondary group. These invariable intensities, which are inexpensive to encode, will contribute to producing a small bitstream and thus save on computing, storage and bandwidth resources.

In E5, watermarking information IT1 is inserted in the images of the secondary group thus formed, for example with the method previously mentioned for step E2. It is assumed that IT1 does not have the same value as IT2. In the case of watermarking information of binary type, if for example IT2=1, then IT1=0 and vice versa.

In the case of information of the n-ary type with n>2, it is understood that it will be necessary to provide n−1 versions of the secondary group.

In E6, the images of the secondary group GS are encoded, using the same encoding scheme as for the main group. By the same encoding scheme is meant an encoding according to the specifications of the same standard, so that the same decoder can decode the main and secondary bitstreams and we also make sure to configure the encoder so as to obtain an encoding quality equivalent to that of the main group. A bitstream TBST1 representative of the secondary group containing the watermarking information IT1 is obtained.

In E10, the bitstreams obtained are formatted for transmission via a telecommunication network and the formatted bitstreams are transmitted. This formatting or encapsulation consists in placing the bitstreams in one or more containers. Such containers include a header with information about the description of the bitstreams transported.

For example, these bitstreams can be transported in MPEG-2 TS (for Transport Stream) format, specified in standard ISO/IEC 13818-1, or ITU-T Rec. H.222.0, or ISOBMFF format already mentioned.

The steps E1 to E7 of the method are then repeated for successive groups of temporal images of the image sequence. Watermarking information can be inserted in all successive image groups or only in some of them. For a next segment, it is possible to choose to insert the same watermarking information IT1, IT2 in the main image group and in the secondary group as in the previous image group. According to one variant, it is possible to change the value inserted from one current group to another, for example to form, using the watermarking information successively inserted into the time groups, the sequence corresponding to the watermark identifier associated with a particular client.

One can also choose to insert watermarking information on a number of groups of images higher than the number of information needed to form the watermark identification sequence of a client. An advantage of repeating the watermarking information sending throughout the image sequence is to ensure that the watermark can be made from an extract of the sequence, provided that it comprises enough groups of temporal images.

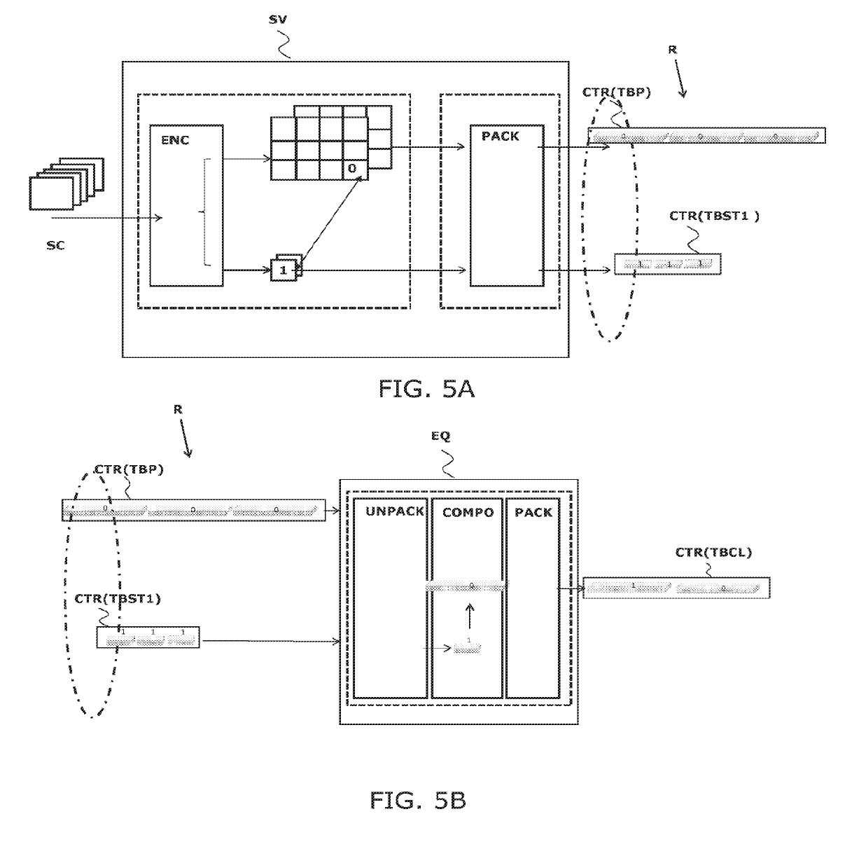

According to the first embodiment of the invention, an exemplary implementation of which is illustrated in FIG. 5A, an SV server forms and transmits, in the telecommunication network, to one or more clients, at least two binary trains:
a main bitstream TBP comprising encoded data representative of groups of images of the sequence of images to be delivered to one or more clients. In one group of images, watermarking information IT2 has been inserted in the middle of the intensity information of at least one watermarking area of the images of the group. Area-based encoding has been applied to the temporal image group so that the encoded data representative of the watermarking area of the images of the group and those representative of the remainder of the images are independent of one another;
at least one secondary bitstream TBST1 comprising encoded data representative of a secondary group comprising “thumbnails” of dimensions equal to those of the watermarking area and, for each image, the intensity information of the watermarking area in the group of original images. In the “thumbnails” of this group, watermarking information IT1 distinct from IT2 has been added. The “thumbnails” of the secondary group have been encoded, using a coding scheme compatible with that used for the main group.
If the watermarking information is n-ary with n>2, we can transmit n−1 secondary bitstreams. As a variant, it is also possible to define several distinct watermarking areas in the images of a group or to transmit the n possible values on n successive segments.

The primary and secondary bitstreams are encapsulated in one or more containers CTR.

According to a first option, illustrated in FIG. 5A, each bitstream is transported independently of the other one(s) in its own container.

According to a second option, not shown, the bitstreams are multiplexed before encapsulating them in one and the same container and transmitting it over the communication network.

According to a third option, not shown, combinable with the first or the second, the bitstreams are segmented in the sense of an adaptive transmission standard, such as DASH, already mentioned for example, before their encapsulation into one or more containers. In this context, the same container can encapsulate segments corresponding to the same group of images, and encoded at different levels of quality.

According to a fourth option, illustrated by FIG. 5B and combinable with the first or the second option, the bitstreams are not segmented at the level of the SV server which implements the method of processing according to the invention. They are transmitted in unsegmented form to an intermediate equipment EQ placed in cut-off of the data streams. This equipment is in charge of segmenting them for delivery to clients, for example in adaptive transmission mode. The interest is to perform a portion of the transmission path in a non-specific transport mode, in a generic configuration and to specify the bitstreams as far downstream as possible. It will be understood that in this case, the client requests the segments from this intermediate equipment EQ, rather than from the server equipment SV.

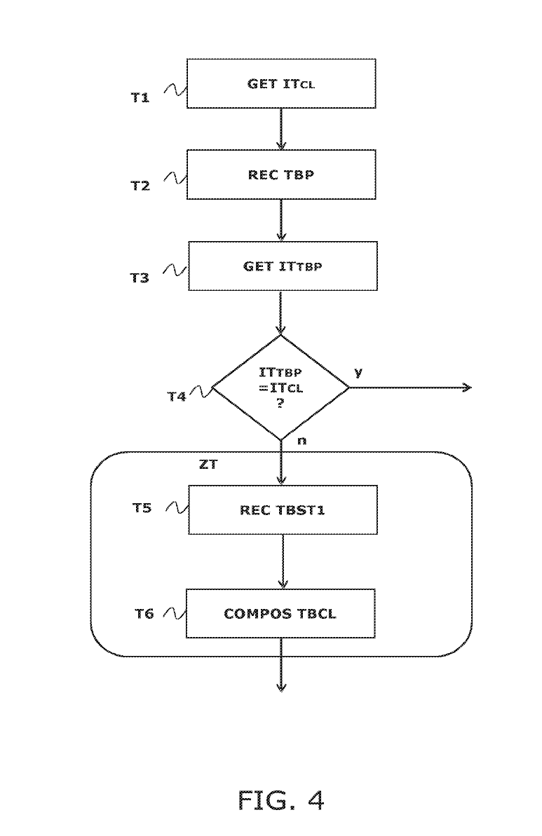

In relation to FIG. 4, the steps of a method for watermarking a sequence of digital images intended for at least one client, according to a first embodiment of the invention, are now described. This method can be implemented within different pieces of equipment on the path followed by the main and secondary bitstreams to an end client. For example, it can be implemented at the level of a client equipment, for example a tablet or a laptop or a set-top-box (TV set-top box) upstream of the decoding of the sequence of images, or in an intermediate equipment, type server or router, which serves multiple clients.

A current group of images GC of the sequence of digital images to be watermarked is considered for delivery to a client. This client is identified by a watermark identifier including a sequence of B watermarking information, with B a non-zero integer.

During a step T1, the value of the watermarking information, for example a binary value, to be inserted into the current group is obtained for at least one client. For example, this information ITCL is equal to IT1. For example, the equipment that implements the watermarking method has previously stored in memory, on the one hand the watermarking information sequence that forms the client's watermark identifier and on the other hand the watermarking information already inserted into previous time segments. The aim is to determine the value of the next watermarking information ITCL to be passed to the client to form the sequence of the client's watermark ID.

For example, it is assumed that it is the i^{th} bit of the watermark identifier IDTCL of the client which comprises B, a non-zero integer, for example equal to 20, which corresponds to more than one million possible identifiers.

In T2, at least the main bitstream TBP, corresponding to the current group GC, is received. If the main bitstream TBP has previously been multiplexed to one or more secondary bitstreams before being encapsulated in a transport container, all bitstreams are necessarily received during this step.

In T3, information about a watermarking information value inserted into the received main bitstream TBP is obtained. For example, if the watermarking information is binary, we get 0 if bit 0 was inserted in the current group, 1 if bit 1 was inserted in the current group and 2 if no bit was inserted into the current group. For example, the equipment that implements the watermarking method has previously obtained the information according to which the main bitstream carries the value IT1 and the secondary bitstream carries the value IT2. As a variant, this information is indicated in the header of the container of the main bitstream TBP.

Advantageously, a flag-type information has been inserted into a field of the transport container of the binary train(s), indicating that a watermarking information has been inserted into the current time segment and complementary fields comprising the watermark indications, such as for example, the value of the watermarking information inserted and the watermarking area where it was inserted.

For a secondary bitstream comprising the encoded data of a spatial area of the images of a segment, the additional information further comprises dependency information with the main bitstream, so that the watermarking device knows how to recompose the full bitstream from the main and the secondary instreams.

A known file format or transport container, such as ISOBMFF, provides areas (“free boxes”) for recording metadata of this type.

In the case of an MPEG-2 TS transport container, this dependency information will advantageously be inserted into a “NAL Unit” sub-container (NALU) intended to transport metadata or coding parameters. We distinguish the parameters of the following types:
SPS (for “Sequence Parameter Set”), which, according to the HEVC standard, are associated with a sequence of images,
PPS (for “Picture Parameter Set”) which are associated with a image (for example, a parameter indicating whether the image is encoded in inter or intra mode), and
SEI (for “Supplemental Enhancement Information”) comprising parameters that are not necessary for decoding, but may be useful (for example, a post-processing filter).

These NALUs are called “non VCL” (for “Video Coding Layer”) because they do not carry video data. For example, the information related to area-based encoding is inserted into the SPS and PPS fields and the information about a watermarking area, about inserting a watermarking information value into this area, and the dependency of a secondary bitstream to a watermarking area of the secondary bitstream are recorded in the SEI field.

In T4, it is determined whether a watermarking area of the current group contains, in the main bitstream, the watermarking information value contained and intended for the client.

If this is the case, the TBP main bitstream can be transmitted to the client without modification. Otherwise, a step T5 for receiving the secondary bitstream TBST1 containing the desired watermarking information is implemented, for the watermarking area considered.

In T6, a new bitstream is formed by replacing the encoded data of the main bitstream corresponding to the watermarking area ZT with those of the secondary bitstream TBST1. The result in the current group is a bitstream TBCL integrating the watermarking information value for the client CL.

This bitstream TBCL specific to the client CL is transmitted to the client in a transport container, for example complies with one of the standards MPEG2 TS or ISO BFF already mentioned.

According to a first option, illustrated in FIG. 5B, there is shown an intermediate equipment EQ implementing the watermarking method according to the invention. This equipment may be intermediate, or the SV server or the end client. This equipment implements the watermarking method according to the first embodiment of the invention.

It receives at least the main bitstream TBP and, depending on the watermarking information ITCL to be transmitted to the client CL, decides whether or not to receive (process) the secondary bitstream TBST1.

In this example, it is considered that the watermarking information contained in the group of the main bitstream is not that for the client CL.

A forming operation is therefore implemented to replace the encoded data of the watermarking area ZT with that of the secondary bitstream TBTS1 and form a client-specific bitstream TBCL for the current group.

If the equipment EQ is an intermediate equipment or the server SV, the bitstream TBCL thus formed is transmitted to the client CL via the network R. If the equipment EQ is the end client, it is transmitted to a decoder.

In the example shown, the intermediate equipment has received the bitstreams in independent containers.

According to a second option, not shown, it has received them as multiplexed into a single container.

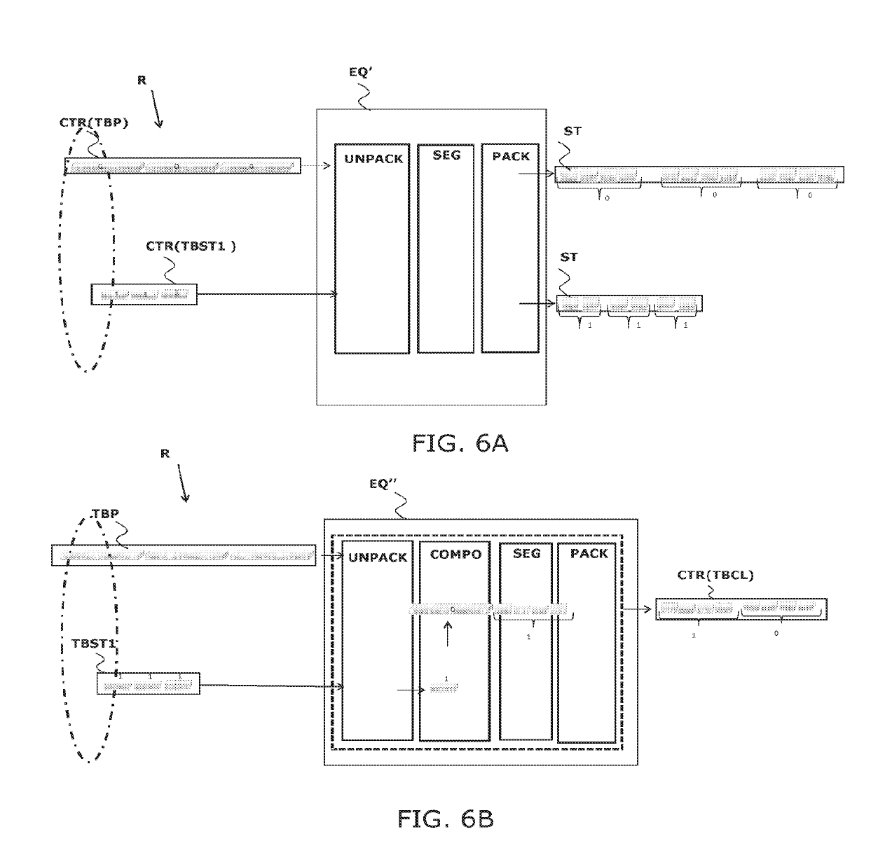

According to a third option, illustrated by FIG. 6A, the bitstreams are segmented by an intermediate equipment EQ′ which does not implement the watermarking method according to the invention. The equipment EQ′ receives the unsegmented bitstreams, extracts them from their container, segments them, encapsulates them again and transmits them in the network to one or more clients. They will then be watermarked by another equipment, intermediary or client. One advantage is that non-segmented bitstreams can be broadcast in multicast mode for example to segmentation equipment.

According to a fourth option illustrated in FIG. 6B and combinable with one of the two previous ones, it has received the unsegmented streams and it implements temporal segmentation at its level. Typically, according to the DASH standard, the time segments used have a size of 1 second, which means that there will be approximately 2 segments per group of images, for a group of 50 images.

In this case, it is understood that the end client will request segments directly from this intermediate equipment EQ″.

This last mode of transport, illustrated by FIGS. 6A and 6B, corresponds to the “mezzanine” mode specified by the MPEG-2 TS standard. According to this mode, the initial bitstreams are prepared at the level of the initial encoding by the server equipment to allow a subsequent “aligned” segmentation for all the bitstreams transported, regardless of the quality of the associated encoding. In other words, the segmentation performs a division at the boundaries between images of different types, for example Intra, Inter type P or Inter type B. This is particularly suited to adaptive transmission, in which a client can request segments of different quality to adapt to variations in transmission conditions in the telecommunication network.

In connection with FIG. 7, the steps of a method for processing a sequence of images according to a second embodiment of the invention are described.

The steps E0 for partitioning, E1 for forming a main group, E2 for forming a secondary group are unchanged.

It will be noted, however, that during step E1, the option already mentioned with reference to FIG. 3 is advantageously chosen, which consists in assigning values of predetermined and invariable intensities in the watermarking area ZT of the images of the main group.

Indeed, according to this second embodiment of the invention, ab initio watermarking information is not inserted into the main group. The watermarking area(s) determined during partitioning of the current group are provided in the main group to subsequently receive the watermarking information value for one or more clients.

During a step E3, the main group is encoded in a conventional manner, in order to obtain a bitstream TBP′.

An advantage of filling the watermarking area(s) with values of predetermined and invariable intensities on the group is to optimise the calculation resources, since encoding is simplified, the storage resources, with a bitstream of smaller size and the transmission resources.

For a watermarking area ZT of the N images of the current group, E4 and E7 are formed at least two secondary groups SS1 and SS2 comprising N “thumbnails” of dimensions equal to that of the area ZT, in a manner similar to that described in relation to with FIG. 3. Advantageously, the “thumbnails” of SS1 and SS2 are assigned the intensity values of the elements of the watermarking area ZT in the current group. It is understood that at this stage, the secondary groups SS1 and SS2 are identical.

During the steps E5 and E8, the watermarking information values IT1 and IT2 are respectively inserted in the secondary groups SS1 and SS2, in a manner similar to that described for the first embodiment of the invention in connection with FIG. 2.

It is assumed that IT1 and IT2 are the two possible watermarking information values, 0 and 1 in binary mode. If this watermarking information is of n-ary type with n>2, n secondary groups will be formed to insert each of the possible values of the watermarking information into a separate secondary group.

During steps E6 and E9, the secondary groups GS1 and GS2 are respectively encoded in a manner similar to that described for the first embodiment of the invention. First and second secondary bitstreams TBST1′ and TBST2′ are obtained.

Advantageously, the binary trains obtained TBP′, TBST1′ and TBST2′ are stored in a memory M. For example, it is a memory of a server equipment implementing the invention.

In E10, the bitstreams obtained are encapsulated in a container, for example as specified in the TS or ISOBMFF standards already mentioned, and they are transmitted via a telecommunication network R.

Steps E0 to E10 are then repeated for the next groups of the image sequence.

Concerning the partitioning step E0, it is possible, for simplicity purposes, to decide to apply the same partitioning and the same choice of positioning of the watermarking area(s) to all the groups of the image sequence.

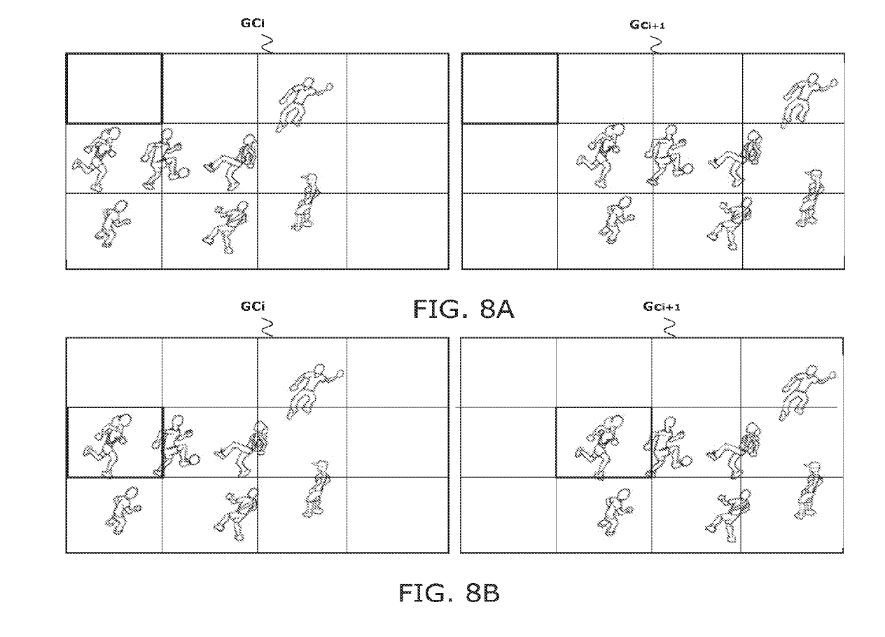

According to a variant, illustrated by FIGS. 8A and 8B, the same partitioning of the images is reproduced on the current group SC, but the positioning of the watermarking area ZT is changed. For example, one chooses to position the watermarking area in a spatial area comprising relevant semantic content. In FIG. 8A corresponding to the current segment SCi, the watermarking area ZT is positioned on a player. In FIG. 8B corresponding to the next segment the watermarking area ZT has been moved to track the player. It is understood that in this case, the method implements a preliminary step of analysing the semantic content of the images of the current segment, for example tracking an object in the image sequence. For example, this analysis is based on a technique known to those skilled in the art and for example described in the document Wren et al, entitled “Pfinder: real-time tracking of the human body”, published in the review IEEE Transactions on Pattern Analysis and Machine Intelligence, Volume:19, Issue: 7, pp. 780-785 ISSN: 0162-8828, in July 1997. This technique consists in using a two-dimensional contour model and a colour histogram model, associated with a MAP type indicator (for “Maximum A Posteriori”), in particular to identify the head, hands and feet of a subject.

This variant is particularly advantageous in the second embodiment of the invention which has just been described, when it has been decided to replace the intensity values of the elements of the watermarking area in the main group with predetermined values. Indeed, if a user illegally captures the main bitstream, the decoded sequence he will obtain will not restore all the relevant content and will offer him a highly degraded experience.

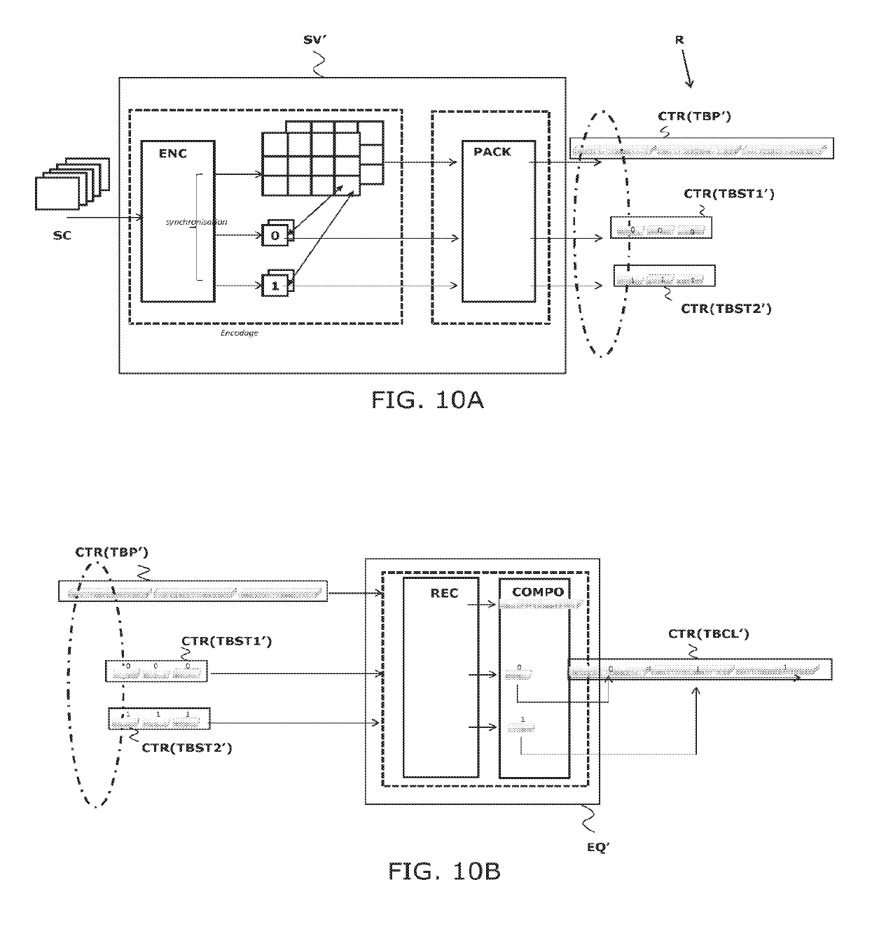

In connection with FIG. 10A, there is shown a server SV implementing the second embodiment of the invention. A current group GC of a image sequence Im is partitioned into spatial areas comprising at least one watermarking area. A main group and a secondary group are formed. No watermarking information is inserted in the main group.

A first watermarking information T1=1 is inserted into the first subgroup and a second watermarking information T2=0 is inserted into the second subgroup.

The three groups are encoded. The main group is area-based encoded so that data from areas other than the watermarking area do not depend on the watermarking area. A main bitstream TBP′ is obtained.

Secondary groups are encoded conventionally. Secondary bitstreams TBST1′ and TBST2′ are obtained.

The binary streams TBP′, TBST1′ and TBST2′ are encapsulated in one, two or three containers which are transmitted to one or more clients via the transmission network R.

The operations are repeated for the next groups in the image sequence.

According to the second embodiment of the invention, at least three bitstreams are transmitted in the telecommunication network to one or more clients:
a main bitstream TBP′ comprising encoded data representative of groups of images of the image sequence to be delivered to one or more clients. At least one watermarking area has been determined in which the intensity values of the elements of the images of the current segment have advantageously been replaced with predetermined values that are more economical to encode. Area-based encoding has been applied to the temporal image group so that the encoded data representative of the watermarking area of the images of the group and those representative of the remainder of the images are independent of one another;
at least one secondary bitstream TBST1′ comprising encoded data representative of a secondary group comprising “thumbnails” of dimensions equal to those of the watermarking area and, for each image, the intensity information of the watermarking area in the group of original images. In the “thumbnails” of this group, watermarking information IT1 distinct from IT2 has been added. The “thumbnails” of the secondary group have been encoded, using a coding scheme compatible with that used for the main group; and
at least one secondary bitstream TBST2′ comprising encoded data representative of a secondary group comprising “thumbnails” of dimensions equal to those of the watermarking area and, for each image, the intensity information of the watermarking area in the group of original images. In the “thumbnails” of this group, IT2 watermarking information distinct from IT1 has been added. The “thumbnails” of the secondary group have been encoded, using a coding scheme compatible with that used for the main group;
If the watermarking information is n-ary with n>2, we can transmit n−1 secondary bitstreams. As a variant, it is also possible to define several distinct watermarking areas in the images of a group or to transmit the n possible values on n successive segments.

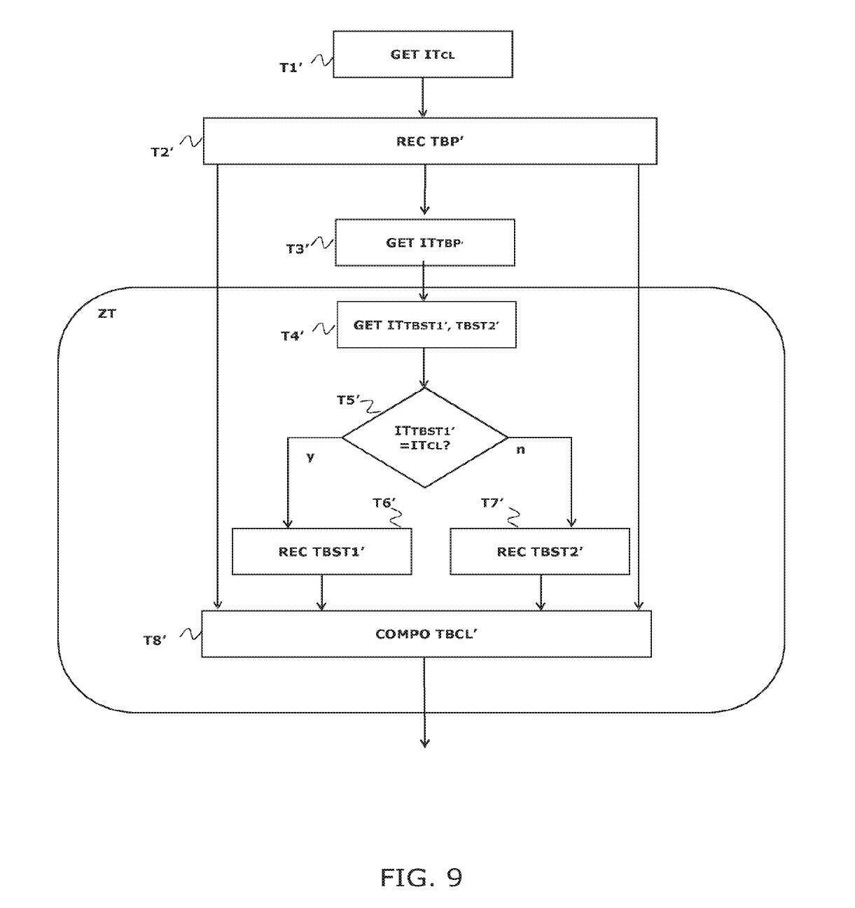

In connection with FIG. 9, the steps of a method for processing a sequence of images according to a second embodiment of the invention are described.

It is assumed that the bitstreams TBP′, TBST1′ and TBST2′ are transmitted to a client equipment via a telecommunication network. The watermarking method that will now be described can be implemented by the client equipment or by a network equipment, for example a server or a router placed at a cut-off of the path of the bitstreams.

A current group of images GC of the sequence of digital images to be watermarked is considered for delivery to a client. This client is identified by a watermark identifier comprising a sequence of B watermarking information, with B a non-zero integer.

The step T1 of obtaining the watermarking information value(s), for example a binary value, to be inserted in the current segment, for the client, is identical to that already described in relation with FIG. 4. For example, this information ITCL is equal to IT1 for the watermarking area ZT.

For example, it is assumed that it is the i^{th} bit of the watermark identifier IDTCL of the client which comprises B, a non-zero integer, for example equal to 20 (which corresponds to more than one million possible identifiers).

In T2′, at least the main bitstream TBP, corresponding to the current group GC, is received. If the primary bitstream TBP has previously been multiplexed to one or more secondary bitstreams before being encapsulated in a transport container, all bitstreams, primary and secondary, are necessarily received during this step.

In T3′, information is obtained relating to a watermarking information value inserted into the watermarking area ZT of the main group corresponding to the main bitstream TBP received. For example, if the watermarking information is binary, we get 0 if bit 0 was inserted in the current group, 1 if bit 1 was inserted in the current group and 2 if no bit was inserted into the current group. For example, this information is reported in the container that encapsulates the main bitstream TBP′.

In this second embodiment of the invention, the main bitstream TBP′ does not contain watermarking information. The information obtained is 2 in the binary case. It is therefore appropriate to receive at least one secondary bitstream.

In T4′, information is obtained relating to the watermarking information values inserted in the secondary bitstreams TBTS1′ and TBTS2′ associated with the main bitstream TBP′ received. For example, the equipment that implements the watermarking process has previously obtained the information according to which the main bitstream carries the value IT1 and the secondary bitstream carries the value IT2. As a variant, this information is indicated in the header of the container of the main bitstream TBP′.

If the watermarking information is binary, we get 0 if bit 0 was inserted in the current group, 1 if bit 1 was inserted in the current group and 2 if no bit was inserted into the current group.

At T5′, it is determined which secondary bitstream contains the watermarking information value to be inserted for the client into the watermarking area ZT. In the remainder of the description, it is assumed that it is ITCL=IT1.

At T6′, the secondary bitstream TBST1′ containing the desired watermarking information is received.

If, on the other hand, it had been desired to insert the watermarking information IT2, it would have implemented the step T7′ of receiving the second secondary bitstream TBST2′.

In T8′, a new bitstream TBCL′ is formed by replacing the coded data of the main bitstream TBP′ corresponding to the watermarking area ZT with those of the secondary bitstream TBST1′. Thus, for the current group, a bitstream TBCL is obtained, integrating the watermarking information value intended for the client CL in the watermarking area ZT.

In connection with FIG. 10B, the bitstreams TBP′, TBST1′ and TBST2′ are received by an equipment EQ which may be intermediate, or the server SV or the end client. This equipment implements the watermarking method according to the second embodiment of the invention.

It processes at least the main bitstream TBP′ that it extracts from its container CTR and, depending on the watermarking information ITCL to be transmitted to the client CL, it chooses the secondary bitstream TBST1′ or TBST2′ to be processed.

In this example, the watermarking information ITCL of the client is considered to be T1. It is contained in the encoded data of the first secondary bitstream TBST1′. The intermediate equipment E′ obtained this information, for example by reading the header of the container of the main bitstream TBP′ or of the secondary bitstream TBST1′, for example a field reserved for the metadata of the transport container.

A forming operation COMPO is therefore implemented to replace the encoded data of the watermarking area ZT with that of the secondary bitstream TBTS1 and form a client-specific bitstream TBCL′ for the current group SC.

If the equipment EQ is an intermediate equipment or the server SV, the bitstream TBCL′ thus formed is encapsulated in a container then transmitted to the client CL via the network R. If the equipment EQ is the end client, it is transmitted to a decoder.

According to a variant, already described for the first embodiment of the invention, the intermediate equipment segments the bitstream TBCL′ formed for the client before encapsulating it in the transport container.

It will be noted that the invention just described, can be implemented using software and/or hardware components. In this context, the terms “module” and “entity” used in this document, can be either a software component or a hardware component or even a set of hardware and/or software, capable of implementing the function(s) outlined for the module or entity concerned.

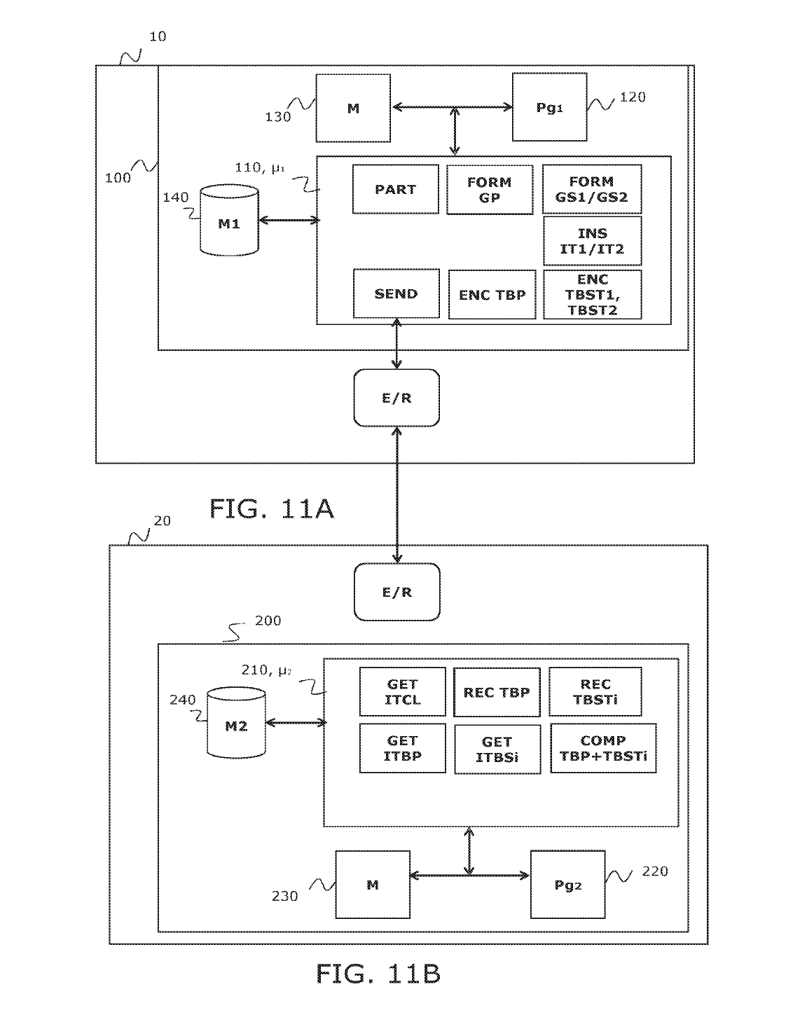

With reference to FIG. 11A, an example of a simplified structure of a device 100 for processing a sequence of digital images according to the invention is now presented. The device 100 implements the processing method according to the invention which has just been described in connection with FIGS. 2 and 5.

For example, the device 100 comprises a processing unit 110, equipped with a processor μ1 and driven by a computer program Pg1 120, stored in a memory 130 and implementing the processing method according to the invention.

At initialisation, the code instructions of the computer program Pg1 120 are for example loaded into a RAM before being executed by the processor of the processing unit 110. The processor of the processing unit 110 implements the steps of the method described above, according to the instructions of the computer program 120.

In this embodiment of the invention, the device 100 comprises at least the following units:
PART for partitioning the images of the current group GC into at least two areas co-located in the images of the group and comprising at least one watermarking area ZT,
FORM GP forming a main group comprising the partitioned images of the current group,
ENC TBP for obtaining a main bitstream representative of an area-based encoding of the main group formed, in which for an area other than said at least one watermarking area, the pixels of that zone are not predicted with reference to pixels in the watermarking area of a image of the group, and for a so-called watermarking area,
FORM GS for forming a secondary group of the same temporal dimension as the main group and of spatial dimensions equal to those of the watermarking area,
INS IT1 for inserting a first watermarking information value IT1 into the secondary group formed,
ENC TBST1 for obtaining a first representative secondary bitstream TBST1 of the encoded secondary group including the first watermarking information value and a transmission unit of the main bitstream and said at least one first secondary bitstream intended for at least one client.

According to a first embodiment of the invention, the device 100 comprises an insertion unit INS T2 of a second watermarking information value IT2 in the watermarking area of the main group.

According to a second embodiment of the invention, the device 100 further comprises the following units:
FORM GS2 for forming a secondary group of the same temporal dimension as the main group and of spatial dimensions equal to those of the watermarking area,
INS IT2 for inserting a second watermarking information value IT2 distinct from IT1 in the secondary group formed, a unit for obtaining a second representative secondary bitstream TBST2 of the encoded secondary group including the second value of watermarking information, and
SEND for transmitting the main bitstream, the first secondary bitstream and said at least second secondary bitstream in the telecommunication network to at least one client. Advantageously, this transmission unit comprises a sub-unit for encapsulating bitstreams in one or more transport containers.

The device 100 furthermore comprises a unit M1 for storing the main and secondary bitstreams obtained.

These units are controlled by the processor μ1 of the processing unit 110.

Advantageously, such a device 100 can be integrated with a server equipment SV. The device 100 is then arranged to cooperate at least with the next module of the server SV:
a data transmission/reception module E/R, through which the bitstreams are transmitted in a telecommunication network, for example a wired, wireless or radio network.

In relation to FIG. 11B, an example of a simplified structure of a device 200 for watermarking a sequence of digital images according to the invention is now presented. The device 200 implements the processing method according to the invention which has just been described in connection with FIGS. 4 and 7.

For example, the device 200 comprises a processing unit 210, equipped with a processor μ2 and driven by a computer program Pg2 220, stored in a memory 230 and implementing the decoding method according to the invention.

At initialisation, the code instructions of the computer program Pg2 220 are for example loaded into a RAM before being executed by the processor of the processing unit 210. The processor of the processing unit 210 implements the steps of the method described above, according to the instructions of the computer program 220.

In this embodiment of the invention, the device 200 comprises at least the following units:
GET IDCL for obtaining beforehand one value representative of at least one watermarking information, so-called client watermarking information, to be inserted into the current group for said at least one client;
REC TBP for receiving a main bitstream comprising the encoded data representative of a main group, formed from the original images of the current group partitioned in at least two predetermined spatial areas. The spatial areas are collocated in the images of the group and include at least one so-called watermarking area. The encoded data are obtained using a main group spatial area encoding, in which the pixel prediction of an area of a image of the segment other than said at least one watermarking area is not made with reference to the pixels of said at least one watermarking area of said image or another image of the group;
GET ITBP for obtaining a piece of information relating to a watermarking information value inserted into the current group of the main bitstream received;
for a watermarking area, the device comprises the following units that can be implemented when the value obtained is not equal to the watermarking information of the client:
   REC TBSTi for receiving at least one first secondary bitstream comprising encoded data representative of images of a secondary group, wherein a watermarking information value equal to the watermarking information of the client has been previously inserted, said group being of the same temporal dimension as the current group and of spatial dimensions equal to those of the watermarking area;
   COMP TBP+TBTSi for forming a bitstream intended for said at least one client, by replacing the encoded data associated with said at least one watermarking area in the main group, with the encoded data of the secondary bitstream.

The device 200 further comprises a unit M2 for storing the compound bitstream.

These units are controlled by the processor μ2 of the processing unit 210.

Advantageously, such a device 200 can be integrated with an equipment EQ located at the cut-off of the path followed by the bitstreams to the client. This is for example the server SV, an intermediate equipment type router or server or a client terminal. The device 200 is then arranged to cooperate at least with the following module of the equipment EQ:
a data transmission/reception module E/R, through which the bitstreams are received from a telecommunication network, for example a radio or radio wired network, by the equipment EQ.

An exemplary embodiment of the present disclosure improves the situation discussed above with respect to the prior art.

An exemplary embodiment in particular overcomes these shortcomings of the prior art.

More precisely, an exemplary embodiment proposes a solution that is more economical in encoding/storage/transmission resources, while remaining robust and adaptive to the different needs of the clients.

An exemplary embodiment of the invention provides a solution that is compatible with current or future standards for transporting bitstreams in a communication network.

It goes without saying that the embodiments which have been described above have been given by way of purely indicative and non-limiting example, and that many modifications can be easily made by those skilled in the art without departing from the scope of the invention.

1. A method for processing a sequence of digital images for transmission to at least one client over a telecommunication network, said sequence being divided into a plurality of groups of images, the images of a group being partitioned into spatial zones, wherein the method comprises the following acts performed by a processing device, implemented for a current group of images:
a) forming a main group comprising the original images of the current group, said images being partitioned into at least two predetermined spatial areas, located at the same spatial coordinates, or collocated, in the images of the current group and comprising at least one watermarking zone;
b) obtaining a main bitstream representative of an area-based encoding of the images of the main group formed, in which for an area other than said at least one watermarking area, the pixels of that zone are not predicted with reference to pixels in the watermarking area of a image of the group;
c) for one said watermarking area:
forming a secondary group of images of the same temporal dimension as the main group and of spatial dimensions equal to those of the watermarking area;
inserting a first watermarking information value into the secondary group formed;
obtaining a first secondary bitstream representative of the images of the encoded secondary group including the first watermarking information value;
d) transmitting the main bitstream and said at least one first secondary bitstream in the telecommunication network to at least one client.

2. The method for processing a sequence of digital images for transmission to at least one client via a telecommunication network according to claim 1, further comprising inserting a second watermarking information, distinct from the first, in the watermarking area of the main group formed.

3. The method for processing a sequence of digital images for transmission to at least one client over a telecommunication network according to claim 1, further comprising:
for a watermarking area:
forming a secondary group of images of the same temporal dimension as the main group and of spatial dimensions equal to those of the watermarking area;
inserting, in the second secondary group formed, at least one second watermarking information value;
obtaining at least one second secondary bitstream comprising encoded data representative of the secondary group including the second watermarking information value;
transmitting said at least one second secondary bitstream to at least one client.

4. The method for processing a sequence of digital images according to claim 3, the act of forming the main group comprises replacing the original intensities of said at least one watermarking area with predetermined intensity values.

5. The method for processing a sequence of digital images according to claim 4, wherein the predetermined values are invariable values.

6. The method for processing a sequence of digital images according to claim 1, wherein the act of forming a secondary group for a watermarking area comprises an extraction of the intensity values of the pixels of the watermarking area in the original images of the current group.

7. The method for processing a sequence of digital images according to claim 1, further comprising choosing said at least one watermarking area among the partitioned areas.

8. The method for processing a sequence of digital images according to claim 1, further comprising determining an enlarged watermarking area in the images of the main group, comprising the area of watermarking and a border of predetermined width around said area, the area-based encoding comprises a step of applying a deblocking filter of size less than or equal to the predetermined width at the borders of the areas of the images of the main group and for an area of a image other than said at least one watermarking area, the prediction of the pixels of the area does not refer to the pixels of said at least one enlarged watermarking area of another image of the group.

9. The method for processing a sequence of digital images according to claim 1, wherein the partitioning implemented in the act of forming the main group comprises at least a first and a second watermarking areas and the act of inserting at least a first watermarking information into the secondary group comprises inserting a first watermarking information into the first area and a third watermarking information into the second area.

10. A device for processing a sequence of digital images for transmission to at least one client over a telecommunication network, said sequence being divided into a plurality of groups of images, said images of a group being partitioned into spatial zones, the device comprising:
a processor; and
a non-transitory computer-readable medium comprising instructions stored thereon, which when executed by the processor configure the device to perform the following acts for a current group of images:
a) forming a main group comprising the original images of the current group, which are partitioned into at least two predetermined spatial areas, located at the same spatial coordinates, or collocated, in the images of the current group and comprising at least one watermarking zone;
b) obtaining a main bitstream representative of an area-based encoding of the images of the main group formed, in which for an area other than said at least one watermarking area, the pixels of that zone are not predicted with reference to pixels in the watermarking area of a image of the group;
c) for one said watermarking area:
forming a secondary group of images of the same temporal dimension as the main group and of spatial dimensions equal to those of the watermarking area;
inserting a first watermarking information value into the secondary group formed;
obtaining a first secondary bitstream representative of the images of the encoded secondary group including the first watermarking information value;
d) transmitting the main bitstream and said at least one first secondary bitstream in the telecommunication network to at least one client.

11. Server equipment comprising the device of claim 10 and being capable of transmitting one or more bitstreams comprising encoded data representative of a video sequence to at least one client equipment.

12. A method of watermarking a sequence of digital images transmitted in a telecommunication network to at least one client, said sequence being divided into groups of images, wherein said method comprises the following acts, implemented by a watermarking device for one such group, so-called a current group:
obtaining beforehand one value representative of at least one watermarking information, so-called client watermarking information, to be inserted into the current group for said at least one client;
receiving a main bitstream comprising encoded data representative of a main group, formed from the original images of the current group partitioned into at least two predetermined spatial areas, located at the same spatial coordinates, or collocated, in the images of the group, and comprising at least one so-called watermarking area, the encoded data having been obtained by encoding each spatial area of the main group, according to which the prediction of the pixels of a image area of the group other than said at least one watermarking area is not made with reference to the pixels of said at least one watermarking area of said image or other image of the group;
obtaining an information relating to a watermarking information value inserted into the current group of the primary bitstream received;
when the value obtained is not equal to the watermarking information of the client, the method furthermore comprises:
for one said watermarking area:
receiving at least a first secondary bitstream comprising encoded data representative of a secondary group of images, wherein a watermarking information value equal to the watermarking information of the client has previously been inserted, said secondary group being of the same temporal dimension as the main group and of spatial dimensions equal to those of the watermarking area;
forming a bitstream intended for said at least one client, by replacing the encoded data associated with said at least one watermarking area in the main group with the encoded data of the secondary bitstream.

13. A device for watermarking a sequence of digital images transmitted in a telecommunication network to at least one client, said sequence being divided into groups of images, wherein said device comprises
a processor; and
a non-transitory computer-readable medium comprising instructions stored thereon, which when executed by the processor configure the device to perform the following acts for one such group, so-called current group:
obtaining beforehand one value representative of at least one watermarking information, so-called client watermarking information, to be inserted into the current group for said at least one client;
receiving a main bitstream comprising the encoded data representative of a main group, formed from the original images of the current group partitioned into at least two predetermined spatial areas, located at the same spatial coordinates, or collocated, in the images of the group, and comprising at least one so-called watermarking area, the encoded data having been obtained by encoding each spatial area of the main group, according to which the prediction of the pixels of a image area of the group other than said at least one watermarking area is not made with reference to the pixels of said at least one watermarking area of said image or other image of the group;
obtaining information relating to a watermarking information value inserted into the current group of the main bitstream received;
when the value obtained is not equal to the watermarking information of the client:
for one said watermarking area:
receiving at least a first secondary bitstream comprising encoded data representative of a secondary group of images, wherein a watermarking information value equal to the watermarking information of the client has previously been inserted, said secondary group being of the same temporal dimension as the main group and of spatial dimensions equal to those of the watermarking area;
forming of a bit stream intended for said at least one client, by replacing the encoded data associated with said at least one watermarking area in the main group with the encoded data of the secondary bitstream.

14. A communication equipment comprising the device for watermarking according to claim 13 and adapted to receive one or more bitstreams comprising encoded data representative of a sequence of images from a server equipment and to transmit them to one or more pieces of recipient client equipment.

15. A client equipment comprising the device for watermarking according to claim 13 and adapted to receive one or more bitstreams comprising encoded data representative of a sequence of images from a server equipment, comprising a decoder adapted to decode the bitstreams received.

16. (canceled)

17. (canceled)

18. A non-transitory computer-readable medium comprising program code instructions stored thereon, which when executed by a processor of a processing device configure the processing device to implement a method for processing a sequence of digital images for transmission to at least one client over a telecommunication network, said sequence being divided into a plurality of groups of images, the images of a group being partitioned into spatial zones, wherein the method comprises the following acts performed by the processing device, implemented for a current group of images:
a) forming a main group comprising the original images of the current group, said images being partitioned into at least two predetermined spatial areas, located at the same spatial coordinates, or collocated, in the images of the current group and comprising at least one watermarking zone;
b) obtaining a main bitstream representative of an area-based encoding of the images of the main group formed, in which for an area other than said at least one watermarking area, the pixels of that zone are not predicted with reference to pixels in the watermarking area of a image of the group;
c) for one said watermarking area:
forming a secondary group of images of the same temporal dimension as the main group and of spatial dimensions equal to those of the watermarking area;
inserting a first watermarking information value into the secondary group formed;
obtaining a first secondary bitstream representative of the images of the encoded secondary group including the first watermarking information value;
d) transmitting the main bitstream and said at least one first secondary bitstream in the telecommunication network to at least one client.

19. A non-transitory computer-readable medium comprising program code instructions stored thereon, which when executed by a processor of a watermarking device configure the watermarking device to implement a method of watermarking a sequence of digital images transmitted in a telecommunication network to at least one client, said sequence being divided into groups of images, wherein said method comprises the following acts, implemented by the watermarking device for one such group, so-called a current group:
obtaining beforehand one value representative of at least one watermarking information, so-called client watermarking information, to be inserted into the current group for said at least one client;
receiving a main bitstream comprising encoded data representative of a main group, formed from the original images of the current group partitioned into at least two predetermined spatial areas, located at the same spatial coordinates, or collocated, in the images of the group, and comprising at least one so-called watermarking area, the encoded data having been obtained by encoding each spatial area of the main group, according to which the prediction of the pixels of a image area of the group other than said at least one watermarking area is not made with reference to the pixels of said at least one watermarking area of said image or other image of the group;
obtaining an information relating to a watermarking information value inserted into the current group of the primary bitstream received;
when the value obtained is not equal to the watermarking information of the client, the method furthermore comprises:
for one said watermarking area:
receiving at least a first secondary bitstream comprising encoded data representative of a secondary group of images, wherein a watermarking information value equal to the watermarking information of the client has previously been inserted, said secondary group being of the same temporal dimension as the main group and of spatial dimensions equal to those of the watermarking area;
forming a bitstream intended for said at least one client, by replacing the encoded data associated with said at least one watermarking area in the main group with the encoded data of the secondary bitstream.
